(19) United States
(12) Patent Application Publication
(10) Pub. No.: US 2015/0199100 A1
(43) Pub. Date: Jul. 16, 2015

(54) INFORMATION PROCESSING APPARATUS, CONTROL METHOD THEREFOR AND STORAGE MEDIUM

(71) Applicant: CANON KABUSHIKI KAISHA, Tokyo (JP)

(72) Inventor: Shiro Kunori, Yokohama-shi (JP)

(21) Appl. No.: 14/128,805

(22) PCT Filed: Oct. 10, 2013
(86) PCT No.: PCT/JP2013/078247

§ 371 Date: Dec. 23, 2013

(30) Foreign Application Priority Data
Oct. 26, 2012 (JP) 2012-237271

(51) Int. Cl. G06F 3/0488; G06F 3/0485

(52) U.S. Cl. CPC G06F 3/0488; G06F 3/0485

(57) ABSTRACT

The present information processing apparatus displays a part of a plurality of items in a form of a list on a display unit, and accepts a touch operation applied by a user to the display unit. When the accepted touch operation is an operation for scrolling the list while being displayed, the list currently displayed on the display unit is scrolled, and control is performed to place undisplayed items in a displayed state and to place information for selecting items included in the list in an undisplayed state. Upon completion of the scroll, control is performed to display information for selecting items that are displayed after the completion of the scroll.

### TECHNICAL FIELD

The present invention relates to an information processing apparatus that prevents erroneous operations when applying a flick operation to flickable content pieces, a control method for the information processing apparatus, and a storage medium.

### BACKGROUND ART

In recent years, information processing apparatuses provided with touchscreens are commonly used. Displayed content pieces can be switched by applying a flick (scroll) operation to a list of a plurality of content pieces (items) displayed on the screens of such information processing apparatuses. Applying a flick operation enables high-speed viewing of a large amount of content. Such a flickable list may display information for designating content pieces in the list (for example, numbers for designating content pieces using hardware keys). The content pieces in the list can be designated by inputting information for designating the same.

When a flick operation is applied to switch display of content pieces, the display of content pieces can be switched at high speed, but it is difficult to quickly find the features of the content pieces, which is problematic. As a solution to this problem, Japanese Patent Laid-Open No. 2009-163055 suggests a technique to perform control to place auxiliary information in an undisplayed state for a predetermined time period or until a predetermined operation is executed after switching content pieces, and to superimpose the auxiliary information over display data after the predetermined time period has elapsed or after completion of the predetermined operation. This can improve visibility immediately after switching content pieces.

However, the above conventional technique has the following problems. For example, when a flickable list displays information for designating content pieces, a user can input information for designating content pieces while display of content pieces is being switched via a flick operation. In this case, as the display of content pieces is switched at high speed, a candidate that is not desired by the user may be selected.

In addition, while the technique described in Japanese Patent Laid-Open No. 2009-163055 improves visibility immediately after switching content pieces, it leaves display data other than auxiliary information displayed while content pieces are being switched. Therefore, with the technique described in Japanese Patent Laid-Open No. 2009-163055, when display data includes information for designating content pieces, there is a possibility that the user inputs such information even during the switching of content pieces and a candidate that is not desired by the user is selected. Moreover, according to the technique described in 2009-163055, it is necessary to wait until a predetermined time period has elapsed or until completion of a predetermined operation after switching content pieces, thereby giving rise to the problem that information for designating content pieces cannot be identified immediately after switching content pieces.

### SUMMARY OF INVENTION

The present invention enables realization of a mechanism for improving visibility and reducing erroneous operations by a user without lowering usability for the user even during the switching of content pieces.

One aspect of the present invention provides an information processing apparatus including a display unit provided with a touchscreen, the apparatus comprising: display control means for displaying a part of a plurality of items in a form of a list on the display unit; accepting means for accepting a touch operation applied by a user to the display unit; and determination means for determining whether or not the touch operation accepted by the accepting means is an operation for scrolling the list while being displayed, wherein when the determination means determines that the touch operation is the operation for scrolling the list while being displayed, the display control means further scrolls the list currently displayed on the display unit, and controls to place undisplayed items in a displayed state and to place information for selecting items included in the list in an undisplayed state.

Further features of the present invention will be apparent from the following description of exemplary embodiments with reference to the attached drawings.

### BRIEF DESCRIPTION OF DRAWINGS

FIG. 1 is a block diagram showing a hardware configuration of an information processing apparatus common to all embodiments of the present invention.

FIG. 2 shows examples of screens displayed on a display of an information processing apparatus according to the first embodiment.

FIG. 3 shows addresses stored in a ROM of the information processing apparatus according to the first embodiment.

FIG. 4 shows examples of screens displayed on the display of the information processing apparatus according to the first embodiment.

FIG. 5 is a flowchart of information processing according to the first embodiment.

FIG. 6 shows an example of a screen displayed on a display of the information processing apparatus common to all embodiments of the present invention.

FIG. 7 shows candidate addresses in a candidate list according to the second embodiment.

FIG. 8 shows examples of screens on a display of an information processing apparatus according to the second embodiment.

FIG. 9 is a flowchart of information processing according to the third embodiment.

### DESCRIPTION OF EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

<Hardware Configuration of Information Processing Apparatus>

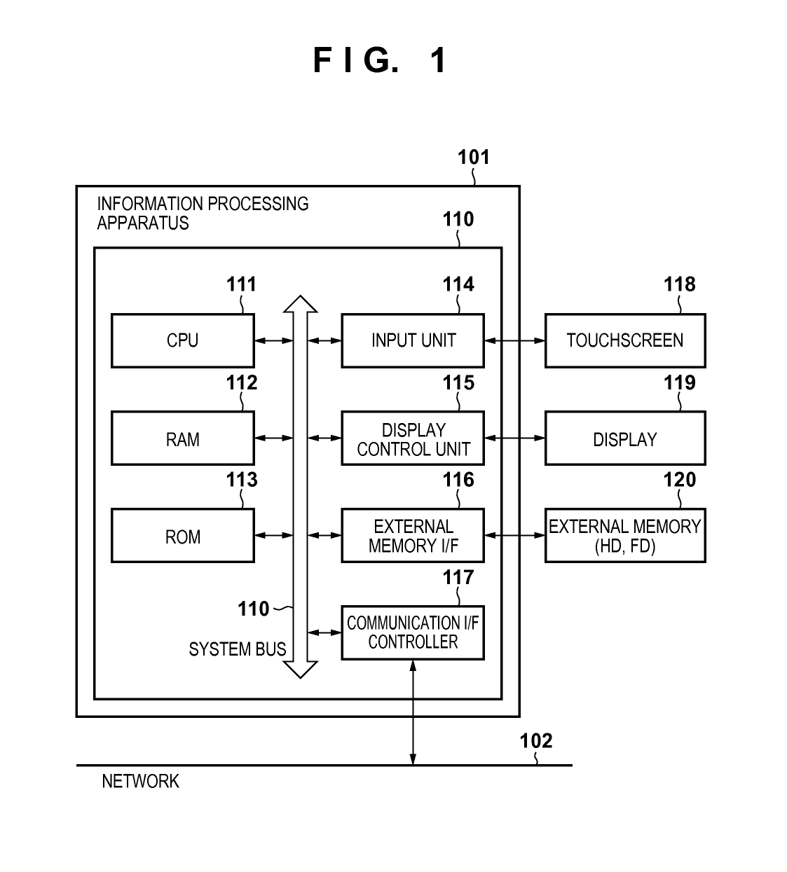

First, a description is given of a hardware configuration of an information processing apparatus 101 common to all embodiments of the present invention with reference to FIG. 1. A CPU 111, a RAM 112, a ROM 113, an input unit 114, a display control unit 115, an external memory I/F 116, and a communication I/F controller 117 are connected to a system bus 110 in the information processing apparatus 101. Also, a touchscreen 118, a display 119 and an external memory 120 are connected to the input unit 114, the display control unit 115 and the external memory I/F 116, respectively. The components connected to the system bus 110 are configured such that they can exchange data with one another via the system bus 110.

The ROM 113 is a non-volatile memory. For example, data such as image data and various types of programs for the operations of the CPU 111 are stored in predetermined areas of the ROM 113. The RAM 112 is a volatile memory and used as a temporal storage area, such as a main memory and a working area, for the CPU 111. The CPU 111 performs overall control of the components of the information processing apparatus 101 using the RAM 112 as a working memory in accordance with control programs stored in the ROM 113. The following description is given under the assumption that the CPU 111 makes determination of every processing using data in the RAM 112 and ROM 113, unless specifically stated otherwise. It is also assumed that data utilized in the determination of processing and the results of processing are all stored in the RAM 112 or ROM 113, and a description thereof is omitted. Programs for the operations of the CPU 111 are not limited to being stored in the ROM 113, and may be pre-stored in the external memory (for example, a hard disk drive) 120.

The input unit 114 accepts a user operation, generates a control signal corresponding to the operation, and supplies the generated control signal to the CPU 111. As an input device accepting a user operation, the input unit 114 accepts input from a USB keyboard, a mouse, the touchscreen 118, and the like. The touchscreen 118 is an input device (interface) to which a touch operation can be applied. For example, the touchscreen 118 outputs coordinate information corresponding to a position that has been touched on a planar input unit. The CPU 111 controls the components of the information processing apparatus 101 based on control signals generated by the input unit 114 in accordance with programs stored in the ROM 113. This enables the information processing apparatus 101 to operate in response to a user operation.

The display control unit 115 outputs a display signal for image display to the display 119. More specifically, when a display control signal generated by the CPU 111 is supplied to the display control unit 115, the display control unit 115 generates a display signal based on the display control signal and outputs the generated display signal to the display 119. The display control unit 115 can also cause the display 119 to display a GUI screen representing a graphical user interface (GUI) based on a display control signal generated by the CPU 111.

The touchscreen 118 and display 119 may be integrally constructed. For example, the touchscreen 118 may be attached to the top layer of a display surface of the display 119, with input coordinates on the touchscreen 118 and display coordinates on the display 119 associated with each other. This makes it possible to provide a GUI that enables the user to operate a screen displayed on the display 119 in a direct manner. The following embodiments are described under the assumption that the touchscreen 118 and display 119 are integrally constructed, and they are collectively referred to as a touchscreen 118.

The external memory 120 and the like can be attached to the external memory I/F 116. Examples of the external memory 120 include a hard disk drive, floppy disk (registered trademark), CD, DVD, and memory card. Therefore, under control by the CPU 111, the external memory I/F 116 can read/write data from/to the attached external memory 120. Under control by the CPU 111, the communication I/F controller 117 performs communication with the network 102. This enables communication with external devices. The network 102 comes in various types, such as a LAN, the Internet, a wired network, and a wireless network.

<Explanation of User Operations>

Next, a description is given of operations applied by the user to the touchscreen 118. When a user applies an operation to the touchscreen 118, the CPU 111 receives a signal transmitted from the input unit 114 and determines what kind of operation has been applied. Operations that can be determined by the CPU 111 include a press operation and a release operation. A press operation is an operation where the user presses the touchscreen 118 using his/her finger (or a stylus). On the other hand, an operation where the user releases the pressed finger after the press operation is called a release operation. When the user attempts to select (designate) a content piece (item) such as a button and a list displayed on the touchscreen 118, the user applies a press operation and a release operation to this content piece. Below, this application of a press operation and a release operation to a content piece is referred to as “selecting”, “designating” or “pressing” a content piece.

Another operation that can be determined by the CPU 111 is a move operation. The move operation includes a sequence of operations. More specifically, in the move operation, while maintaining a press operation applied to the touchscreen 118, a pressed finger is moved on the touchscreen 118 and then released through a release operation. A move operation performed during a pre-set short time period is referred to as a flick operation. More specifically, a flick operation is a quick movement or flick of a finger on the touchscreen 118. For instance, in the case where only some of the content pieces in a list are displayed, the move operation and flick operation are used to display content pieces in an undisplayed state. Performing the move operation switches display of content pieces from the position to which a press operation was applied to the position to which a release operation was applied in response to the movement of the finger. On the other hand, performing the flick operation switches display of content pieces included in the list from the position to which a press operation was applied in response to the movement of the finger, but makes the switching of display of content pieces included in the list continue for a certain time period after a release operation. The switching of display is finished after such continuation. The above operations are the same as general move and flick operations, and a specific description thereof is omitted. Below, a part of content in the list that is displayed is referred to as a display area of the list, and a status where content pieces displayed in the display area of the list are being switched by a flick operation applied to the list is referred to as “during a flick performance”. A flick performance means to scroll a list while being displayed in response to a flick operation.

### First Embodiment

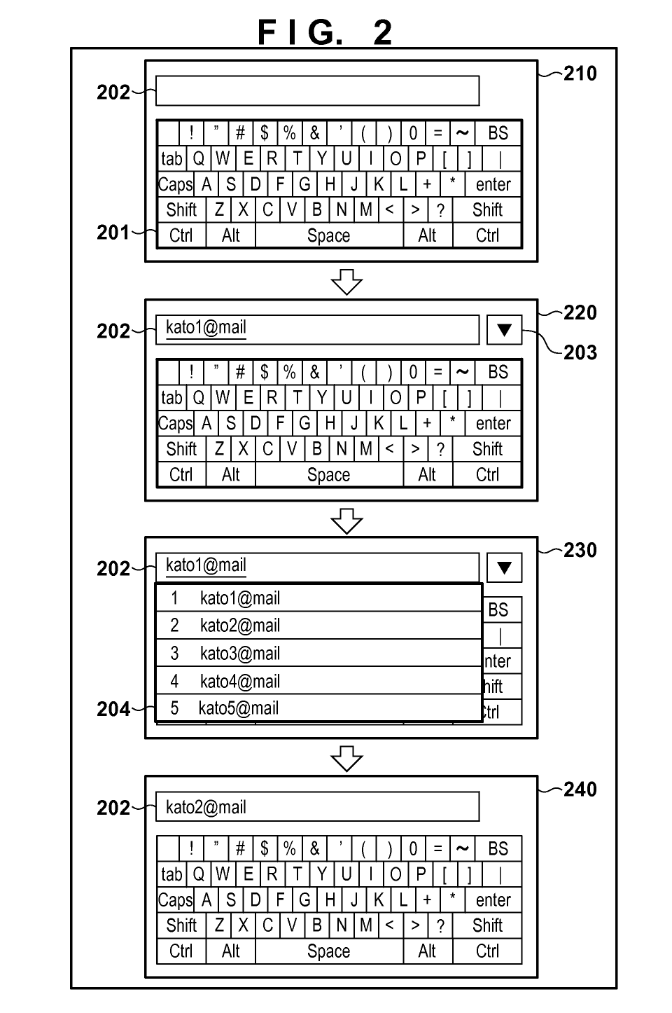

The following describes the first embodiment of the present invention with reference to FIGS. 2 to 6. First, a description is given of examples of display on the touchscreen 118 of the information processing apparatus 101 with reference to FIG. 2. FIG. 2 shows software keyboard screens for inputting an address of a destination in an e-mail transmission function, which is one of data transmission functions provided by the information processing apparatus 101. Below, a user operation for inputting an address of a destination on these software keyboard screens, and internal processing for the user operation, are explained in this order.

<Input of Address on Software Keyboard Screen (User Operation)>

An address of a destination is input by the user on a software keyboard screen displayed on the touchscreen 118. More specifically, a software keyboard screen as shown in 210 is used. This software keyboard screen includes an input key area 201 and an input area 202. The input key area 201 has a plurality of software-like character input keys for inputting characters. The input area 202 displays the input characters. The user can cause the input area 202 to display a character by applying a press operation and a release operation successively in this order to a key in the input key area 201. These operations are the same as general character input on a software keyboard screen and are simply referred to as “character input” below, unless specifically stated otherwise.

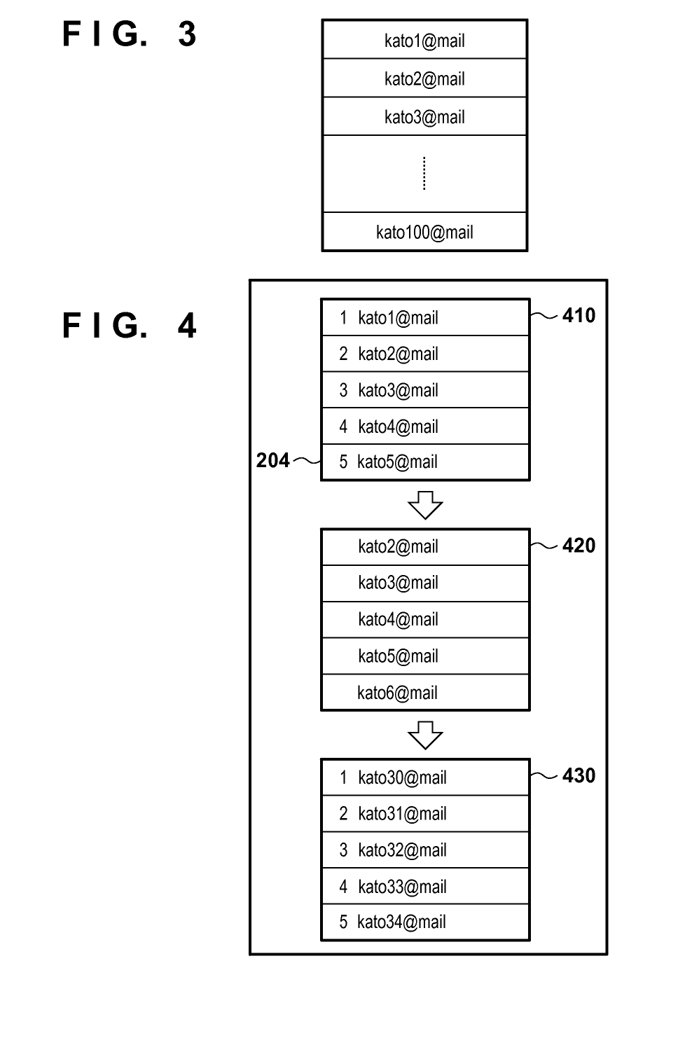

A general complementary function (hereinafter referred to as an autocomplete function) can be used on this software keyboard screen. More specifically, by inputting a character, candidates of character strings starting with that character (in the present scenario, e-mail addresses of destinations) can be displayed in the input area 202. Data that is not actually input is referred to as a complementary character, and a candidate of data starting with that character is referred to as a candidate address. A specific example of an address input utilizing this autocomplete function is described below under the assumption that, as shown in FIG. 3, candidates “kato1@mail” through “kato100@mail” are stored as candidate addresses starting with “k” in order of priority (in the present scenario, in alphabetical order).

First, the user inputs the character “k”. As a result, “kato1@mail”, which is one of the candidate addresses, is displayed in the input area 202 and a candidate display button 203 for displaying other candidate addresses is displayed as shown in 220. In FIG. 2, complementary characters “ato1@mail” are displayed with an underline so as to distinguish them from the character that was actually input.

When the user presses an OK key (for example, an enter key in the input key area 201) in the status of 220, the complementary characters in the input area 202 are fixed (the underline is removed), and the address of the destination is determined. On the other hand, when the user presses the candidate display button 203 in the status of 220, a candidate list 204 including a plurality of candidate addresses starting with the input character is displayed as shown in 230.

In this candidate list 204, the candidate addresses are arranged in rows. By applying a flick operation to the candidate list 204, the candidate list 204 can be scrolled while being displayed. A display area of this candidate list 204 displays a predetermined number of candidate addresses (in FIG. 2, five candidate addresses). Undisplayed candidate addresses can be displayed by the later-described flick operation. Furthermore, candidate addresses displayed in the display area of this candidate list 204 are associated one-to-one with numbers for selecting the same (hereinafter, these numbers are referred to as candidate designation numbers). A candidate designation number and an associated candidate address are displayed together in one line in the display area. Below, the topmost line of the display area is referred to as a head line of the display area.

The user can designate an address of a destination from the candidate list 204 by pressing any line displaying a candidate address in the candidate list 204 on the touchscreen 118. The user can also designate an address of a destination by inputting any candidate designation number displayed in the display area using a USB keyboard (not shown in the figures) or numeric keys (hardware keys) provided on the display 119. Below, input made using the USB keyboard or numeric keys is referred to as input from an external input device so as to distinguish the same from input made by pressing a content piece of the candidate list 204.

Once a desired address has been selected from among a plurality of candidate addresses through the above operations, the candidate display button 203 and candidate list 204 are placed in an undisplayed state, the selected address is displayed in the input area 202, and the address of the destination is determined. Provided that the user input “2” using the USB keyboard, display is performed as shown in 240 and “kato2@mail” is determined as the destination.

<Flick Operation to Candidate List>

Next, a description is given of a specific example of a flick operation to the above-described candidate list 204 with reference to FIG. 4. FIG. 4 only shows the candidate list 204 of 230.

When the user applies an upward flick operation to the candidate list 204 shown in 410 (when a flick performance is started), the candidate designation numbers that were displayed in the lines of the display area of the candidate list 204 are placed in an undisplayed state, and switching of the candidate addresses displayed in the display area is started. In FIG. 4, 420 shows momentary display during the flick performance. Thereafter, once the switching of display of candidate addresses has been finished (once the flick performance has been finished), candidate designation numbers are associated one-to-one with candidate addresses currently displayed in the display area of the candidate list 204, and each candidate designation number is displayed in the same line as the associated candidate address. For example, if “kato30@mail” is in the head line of the display area of the candidate list 204 upon completion of the flick performance, display is such as shown in 430.

When a candidate designation number is input from the external input device after completion of a flick performance in the status of 430, a candidate address associated with the input candidate designation number is determined as a destination. On the other hand, when a candidate designation number is input from the external input device during the flick performance in the status of 420, this input is ignored because the candidate designation numbers are not displayed. Similarly, when the touchscreen 118 is pressed during the flick performance in the status of 420, this input is ignored as well.

<Input of Address on Software Keyboard Screen (Internal Processing)>

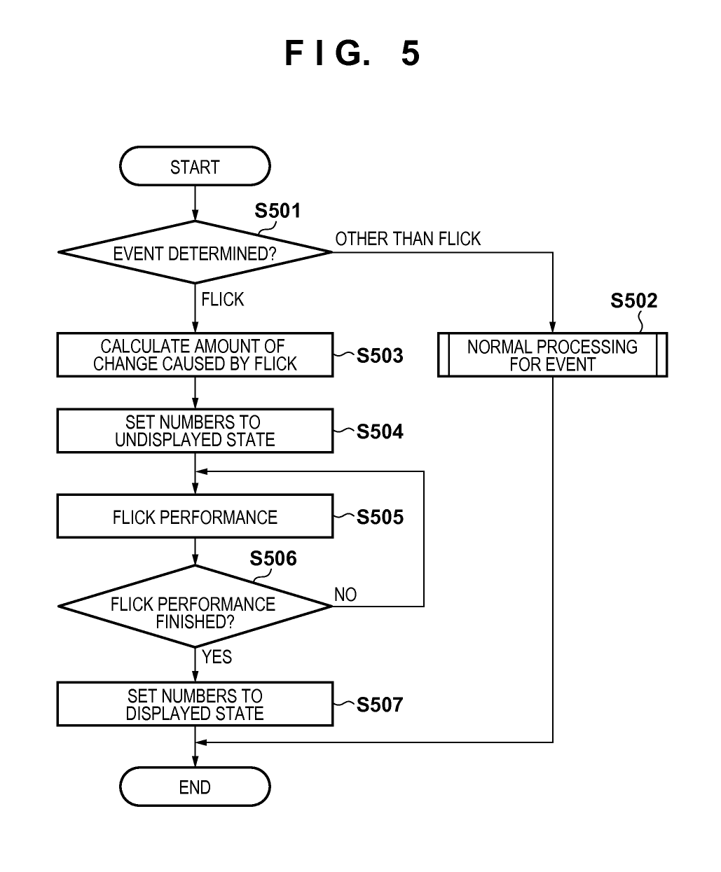

Below is a description of a procedure for internal processing executed when the above-described user operation is performed with reference to FIG. 5. First, a description is given of internal processing executed when the user displays the candidate list 204 using the autocomplete function. It should be noted that the processing described below is realized by the CPU 111 reading control programs stored in the ROM 113 to the RAM 112 and executing the read control programs.

First, in S501, upon detecting an event from the input unit 114, the CPU 111 determines whether or not this event is a flick operation. The CPU 111 proceeds to S503 when this event is a flick operation, and to S502 when this event is not a flick operation. For example, when the user has input “k”, the CPU 111 determines that this event is not a flick operation, executes general processing for software keyboard input using the autocomplete function in S502, and ends the processing. More specifically, the CPU 111 displays “k” in the input area 202, and further determines whether or not the ROM 113 stores any address starting with “k”. When the ROM 113 stores addresses starting with “k”, the CPU 111 extracts one address with the highest priority from the ROM 113, and displays the extracted address in the input area 202 using the display control unit 115. The CPU 111 further displays the candidate display button 203 using the display control unit 115. It is assumed here that the ROM 113 stores a hundred addresses starting with “k” as shown in FIG. 3.

Meanwhile, when the user selects the candidate display button 203 while the candidate display button 203 is displayed, the CPU 111 similarly detects an event from the input unit 114 and determines whether or not this event is a flick operation in S501. In this case, as this event is not a flick operation, the CPU 111 proceeds to S502, executes general candidate display processing using the software keyboard, and ends the processing. More specifically, based on information transmitted from the input unit 114, the CPU 111 detects that the candidate display button 203 has been pressed. Accordingly, the CPU 111 extracts candidate addresses starting with the input character from the ROM 113 in order from the highest priority, and stores the extracted candidate addresses in the RAM 112. The CPU 111 then extracts, from among the candidate addresses stored in the RAM 112, as many candidate addresses as the display area of the candidate list 204 can display (in the present scenario, five candidate addresses). Thereafter, the CPU 111 associates the candidate addresses to be displayed in the display area one-to-one with numbers “1” through “5”, and stores them in the RAM 112. The CPU 111 also stores a candidate address that is displayed in the head line of the display area of the candidate list 204 (hereinafter referred to as a head address currently displayed) in the RAM 112. This head address currently displayed is used at the time of the later-described flick operation. Then, as shown in 230 of FIG. 2, the CPU 111 extracts the numbers and candidate addresses associated therewith from the RAM 112, and displays the extracted numbers and candidate addresses in the display area of the candidate list 204 using the display control unit 115. In the case of 230, the CPU 111 associates the candidate addresses “kato1@mail” and “kato2@mail” with the numbers “1” and “2”, respectively, and stores them in the RAM 112. The CPU 111 similarly associates the subsequent candidate addresses one-to-one with the numbers “3” through “5”, and stores them in the RAM 112. As a result of this association, when a number is input from an external input device such as a USB keyboard, a candidate address associated with the input number can be extracted. In the case of 230, the CPU 111 also stores “kato1@mail” in the RAM 112 as the head address currently displayed. This concludes the description of the internal processing for displaying the candidate list 204.

Next, a description is given of internal processing executed when a flick operation is applied to the candidate list 204. In S501, the CPU 111 detects an event from the input unit 114 and determines whether or not this event is a flick operation. When the user applies an upward flick operation to the candidate list 204, the CPU 111 determines that this event is a flick operation, proceeds to S503, and calculates an amount of change caused by this flick operation. This amount of change is used in determining a candidate address to be displayed in the head line of the display area of the candidate list 204 upon completion of the flick performance (hereinafter referred to as a post-flick candidate address). This post-flick candidate address is calculated using a mathematical formula pre-stored in the ROM 113, based on a difference between coordinates related to a press operation and coordinates related to a release operation during the flick operation and on a time period required between the press operation and the release operation. A detailed description of such calculation is omitted. It is assumed here that the calculated post-flick candidate address is “kato30@mail” as shown in 430 of FIG. 4.

When calculation of the amount of change caused by the flick operation is finished in S503, the CPU 111 proceeds to S504 and sets the display setting of the candidate designation numbers stored in the RAM 112 (hereinafter referred to as candidate number display setting) to an undisplayed state as shown in 420. This candidate number display setting is the setting as to whether or not to display the numbers “1” through “5” for designating the associated candidate addresses in the lines of the display area of the candidate list 204. A default setting value for the candidate number display setting is stored in the RAM 112. When this setting is set to an undisplayed state, control is performed such that the numbers “1” through “5” are not displayed in the lines of the display area, and the input of numeric values “1” through “5” from an external input device such as a USB keyboard is ignored.

After changing the candidate number display setting in S504, the CPU 111 proceeds to S505 and controls the display control unit 115 to continuously switch the display of the candidate addresses in the candidate list 204 from the head address currently displayed, which is stored in the RAM 112, to the post-flick candidate address. In this way, from the user's point of view, the candidate addresses in the candidate list 204 appear to be moving upward one by one. This display operation is the same as the display during a normal flick operation. From the user's point of view, the candidate addresses appear to be scrolled upward.

Next, in S506, the CPU 111 determines whether or not the flick performance has been finished by determining whether or not the post-flick candidate address calculated in S503 has reached the head line of the display area. When the CPU 111 determines that the flick performance has not been finished, the CPU 111 repeats S505 to switch the display of the candidate list 204. On the other hand, when the CPU 111 determines that the flick performance has been finished, the CPU 111 associates the candidate addresses currently displayed in the display area of the candidate list 204 one-to-one with the numbers “1” through “5”, and stores them in the RAM 112. Then, in S507, the CPU 111 sets the candidate number display setting in the RAM 112 to a displayed state, displays these numbers and candidate addresses using the display control unit 115, and ends the processing. The CPU 111 also changes the head address currently displayed in the RAM 112 to the post-flick candidate address. When the post-flick candidate address is “kato30@mail” as shown in 430, the CPU 111 associates the candidate addresses “kato30@mail” and “kato31@mail” with the numbers “1” and “2”, respectively, and stores them. The CPU 111 similarly associates the subsequent candidate addresses one-to-one with the numbers “3” through “5”, and stores them. The head address currently displayed is “kato1@mail” in 410, and “kato30@mail” in 430. This concludes the description of the internal processing executed when a flick operation is applied to the candidate list 204.

Finally, a description is given of internal processing executed when a desired address is selected from the candidate list 204. The user selects a desired candidate address while it is displayed in the display area of the candidate list 204. This selection can be made by pressing a line displaying the desired candidate address within the candidate list 204, or by inputting a candidate designation number for designating the desired candidate address from an external input device such as a USB keyboard.

In S501, the CPU 111 detects an event from the input unit 114 and determines whether or not this event is a flick operation. In this case, as this event is not a flick operation, the CPU 111 proceeds to S502, executes general software keyboard input processing, and ends the processing. It is assumed here that a numeric value has been input from the external input device. Accordingly, the CPU 111 extracts a candidate address associated with the input candidate designation number from the RAM 112, displays the extracted candidate address in the input area 202 using the display control unit 115, and determines the address of the destination. The CPU 111 then places the candidate list 204 and the candidate display button 203 in an undisplayed state using the display control unit 115. More specifically, when “2” is input from the external input device in the status of 430, “kato31@mail” is displayed in the input area 202 as the address of the destination. While a numeric value is input from the external input device in the above description, in the case where a line displaying a desired address in the display area has been pressed, the CPU 111 similarly extracts a candidate address corresponding to the pressed position from the ROM 113, and the subsequent processes are the same as the above-described processes. This concludes the description of the internal processing for inputting an address using the software keyboard.

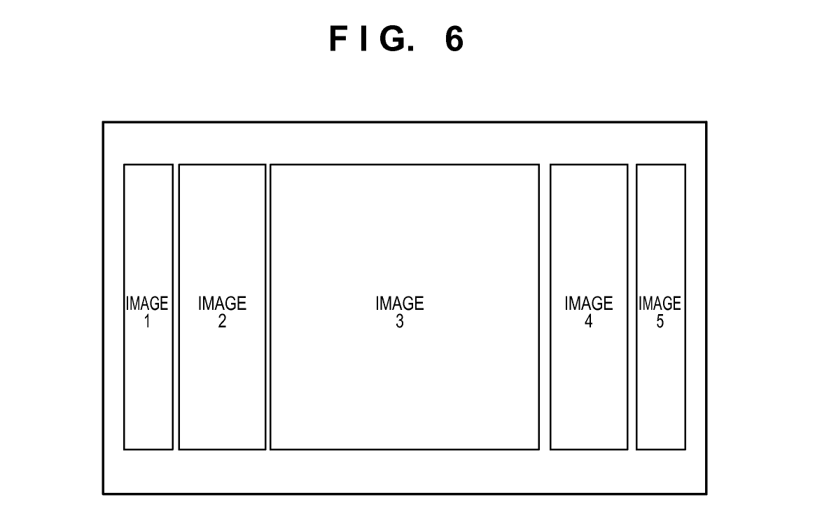

As set forth above, during a flick performance (while the display of the candidate list 204 is being switched), control is performed to place candidate designation numbers in an undisplayed state, and the input of such candidate designation numbers is disabled (discarded). This makes it possible to prevent the user from selecting an undesired candidate by mistake. Furthermore, as candidate designation numbers are displayed again after the flick performance is finished, the user can select a candidate address immediately after the flick performance is finished. Therefore, the usability is not impaired. While the present embodiment has described the processing where a flick operation is applied to a list of candidate addresses, the present invention is not limited in this way. The above processing is also applicable to other flickable content pieces. For example, the above processing is also applicable to a flick operation applied to a screen displaying a list of a plurality of images (image 1 through image 5) shown in FIG. 6.

### Second Embodiment

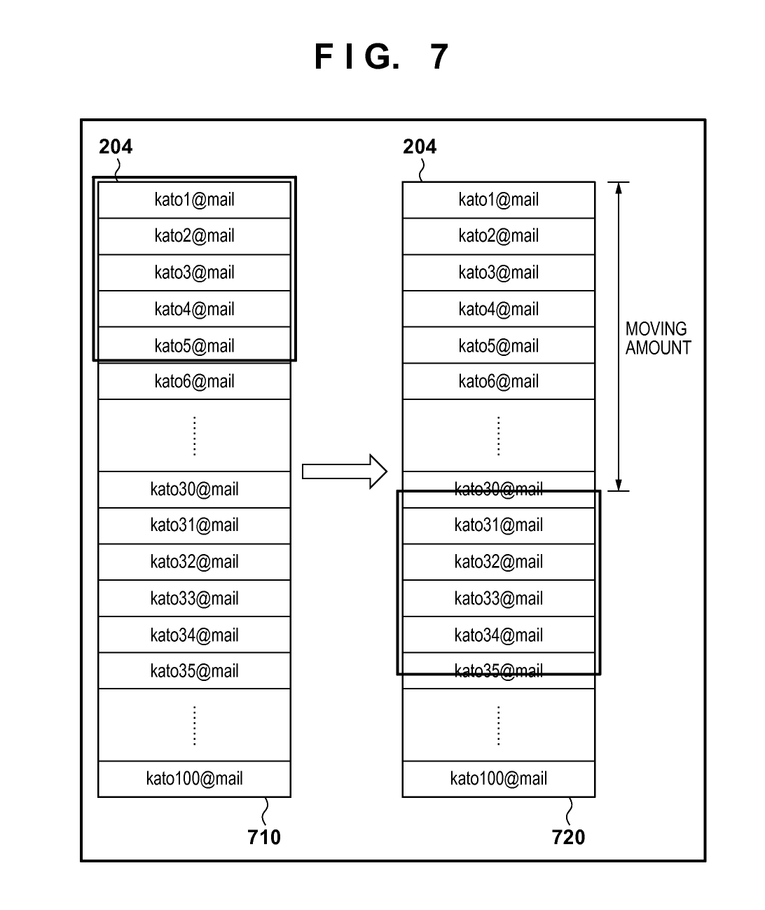

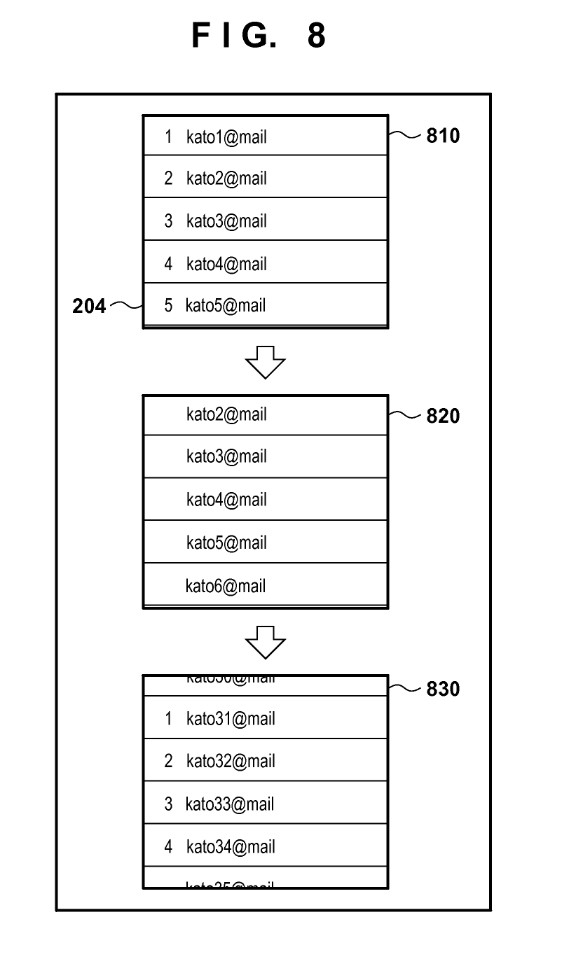

The following describes the second embodiment of the present invention with reference to FIGS. 7 and 8. In the above-described first embodiment, the post-flick candidate address is used for the amount of change caused by a flick operation. On the other hand, the present embodiment describes the case where a moving amount of a display area of a conversion candidate list is used for the amount of change caused by a flick operation. It should be noted that basic processing and control are the same as the above-described first embodiment. Therefore, the following describes only the portions that are different from the first embodiment with reference to FIG. 5. As the processes up to the display of the conversion candidate list on a software keyboard screen are the same as the above-described first embodiment, internal processing following the display of the conversion candidate list is described below.

When the user applies a flick operation to a change candidate list 204, the CPU 111 detects an event from the input unit 114 and determines whether or not this event is a flick operation in S501. In this case, as the event is a flick operation, the CPU 111 proceeds to S503 and calculates an amount of change caused by this flick operation. In the present embodiment, a moving amount of the display area of the candidate list 204 is calculated as this amount of change. More specifically, this moving amount of the display area is calculated using a mathematical formula pre-stored in the ROM 113 based on a difference between coordinates related to a press operation and coordinates related to a release operation during the flick operation, an operation time period, the height of the entire display area of the candidate list 204, and the height of each line in the display area. This moving amount of the display area is calculated as a moving amount of a predetermined unit corresponding to the flick operation (for example, 1 cm per predetermined manipulated value). The display area is moved by the calculated moving amount as shown in FIG. 7.

A specific example is explained below with reference to FIG. 7. In FIG. 7, 710 illustrates which part of the candidate list 204 is the display area. In 710, the display area of the candidate list 204 is shown with a bold frame. The present embodiment is described under the assumption that each line in the display area has a height of 1 cm and the display area has a height of 5 cm, and these heights are pre-stored in the ROM 113 together with the candidate addresses “kato1@mail” through “kato100@mail” shown in FIG. 3.

Assume that the user has performed a flick operation in this status and the moving amount of the display area calculated by the CPU 111 is 29.5 cm. In this case, the position of the display area shown in 710 moves to the position of the display area shown in 720. Below, candidate addresses whose line content pieces are not entirely displayed in the display area, such as “kato30@mail” and “kato35@mail” in 720, are referred to as partially-displayed candidate addresses. On the other hand, candidate addresses whose line content pieces are entirely displayed in the display area, such as “kato31@mail” and “kato32@mail”, are referred to as entirely-displayed candidate addresses. Candidate addresses mentioned without any particular description are regarded as entirely-displayed candidate addresses.

After calculating the amount of change in S503, the CPU 111 performs control to set the candidate number display setting to an undisplayed state in S504 and starts a flick performance in S505 as with the first embodiment. Thereafter, in S506, the CPU 111 determines whether or not the flick performance has been finished by determining whether or not the display area of the candidate list 204 has moved by the moving amount calculated in S503. This determination using the moving amount calculated in S503 differs from the first embodiment.

When the CPU 111 determines that the flick performance has been finished in S506, the CPU 111 sets the candidate number display setting in the RAM 112 to a displayed state as with the first embodiment. In the present embodiment, the CPU 111 further determines whether the candidate addresses displayed in the candidate list 204 are partially-displayed candidate addresses or entirely-displayed candidate addresses, associates only the entirely-displayed candidate addresses one-to-one with candidate designation numbers, and stores them in the RAM 112. Then, in S507, the CPU 111 displays the candidate designation numbers and candidate addresses in the display area of the candidate list 204 as with the first embodiment. For example, when the flick operation causes the display area to move by 29.5 cm, the candidate list 204 shown in 810 of FIG. 8 changes to the candidate list 204 shown in 830 of FIG. 8 after the flick performance. In FIG. 8, 820 shows momentary display during the flick performance. In this manner, while the entirely-displayed candidate addresses “kato31@mail” through “kato34@mail” are displayed together with candidate designation numbers, the partially-displayed candidate addresses “kato30@mail” and “kato35@mail” are displayed without candidate designation numbers. That is to say, in the present embodiment, only the entirely-displayed candidate addresses are displayed in a selectable manner.

As set forth above, the information processing apparatus according to the present embodiment makes only the entirely-displayed candidate addresses selectable. In this way, the user can select only candidate addresses whose content pieces can be entirely checked, and can therefore designate a desired address in a more reliable manner.

### Third Embodiment

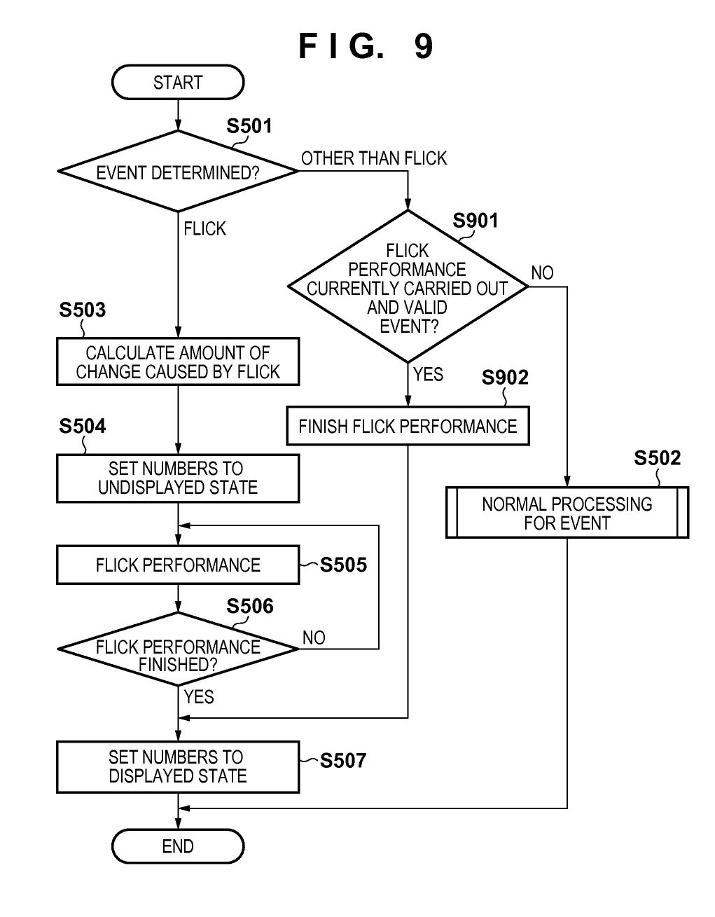

A description is now given of the third embodiment with reference to FIG. 9. In the above-described first embodiment, when a candidate designation number is input from an external input device such as a USB keyboard during a flick performance, this input is completely disabled. Unfortunately, in this case, a user needs to wait to perform an operation until the flick performance is completed, which may be stressful to the user. As a solution to this problem, the present embodiment describes a technique to finish the flick performance in accordance with the input content from the external input device. It should be noted that basic processing and control are the same as the above-described first embodiment. Therefore, the following describes only the portions that are different from the first embodiment.

FIG. 9 shows a processing procedure of the information processing apparatus 101 according to the present embodiment. It should be noted that the processing described below is realized by the CPU 111 reading control programs stored in the ROM 113 to the RAM 112 and executing the read control programs. As the processes other than S901 and S902 are the same as the first embodiment, a description thereof is omitted below. The following describes internal processing executed after starting a flick performance on a conversion candidate list displayed on a software keyboard screen.

In S501, the CPU 111 detects an event from the input unit 114 and determines whether or not this event is attributed to a flick operation. When the CPU 111 determines that this event is not a flick operation, the CPU 111 proceeds to S901 and determines whether or not the following conditions are both satisfied: a flick performance is currently carried out, and the detected event is valid in the candidate list 204. This determination is made based on a determination as to whether or not a flick performance is currently carried out (whether or not the result of S506 is NO), and on a determination as to whether or not the detected event is valid in the candidate list 204 after the flick performance is finished. A specific example is described in detail below, separately for the status where the flick performance is currently carried out and the status where the flick performance is not currently carried out.

Assume, as the status where the flick performance is currently carried out, that a flick operation has been applied to the candidate list 204 shown in 410, resulting in the display area of the candidate list 204 shown in 420. In this status, as the input of “1” through “5” is accepted as a candidate designation number after completion of the flick performance, “1” through “5” are valid numbers in this candidate list 204. Therefore, when the user inputs “2” as a candidate designation number from the external input device in the status of 420, the CPU 111 determines that the input event “2” is valid and proceeds to S902. When the user inputs “6” from the external input device, the CPU 111 determines that this input is invalid, proceeds to S502, and disables the event.

On the other hand, assume, as the status where the flick performance is not currently carried out, that the candidate list 204 shown in 410 is displayed. In this status, as “1” through “5” are valid numbers in the candidate list 204, when the user inputs “2” from the external input device, the CPU 111 determines that the input event is valid. Then, in S502, the CPU 111 determines the candidate address associated with “2” as the destination. When the user inputs “6” from the external input device, the CPU 111 determines that the input of “6” is invalid because only the input of “1” through “5” is valid in the candidate list 204, and accordingly disables the event in S502. This concludes the description of the state where the flick performance is currently carried out and the state where the flick performance is not currently carried out.

When the CPU 111 determines in S901 that the event is valid during the flick performance, the CPU 111 stops the switching of the candidate addresses displayed in the candidate list 204, finishes the flick performance in S902, and proceeds to S507. In S507, the CPU 111 displays the candidate designation numbers “1” through “5” in the candidate list 204 as with the first embodiment.

According to the present embodiment, even during a flick performance, an event from the external input device is received and the switching of the candidate addresses displayed in the candidate list 204 is stopped. In this way, there is no need to wait until the switching of the candidate list 204 is completed. Furthermore, in the present embodiment, a determination to stop the switching of the candidate addresses is not made for all events, but is made only for events that are valid in the candidate list 204 after the flick performance. This prevents a situation where the switching of display is stopped by an event generated by an erroneous operation by a user, thus making it possible to stop the switching of display in accordance with the user's intensions.

In S902 of the present embodiment, instead of simply finishing the flick performance, the flick performance may be stopped after displaying a candidate address corresponding to the event that has been determined to be valid in the head line of the display area of the candidate list 204. In S901 of the present embodiment, the input from the external input device is used as an event whose validity is to be determined. Alternatively, a press operation applied by the user to the display 119 may be used as an event whose validity is to be determined. That is to say, when an event of a press operation is for the candidate list 204, this event may be determined to be valid.

### Other Embodiments

The above embodiments have described the case where a list is scrolled while being displayed in response to a flick operation. Alternatively, the present invention may also be applied to other operations for scrolling a list while being displayed, such as a move operation described above. During a flick operation, it is difficult for a user to deliberately adjust the scrolling speed. In contrast, during a move operation, a user operation and the scrolling speed are synchronous with each other, and therefore it is relatively easy for the user to deliberately adjust the scrolling speed. In other words, during a move operation, there is a possibility that no problem occurs even if the input of a candidate designation number is enabled during the scroll; enabling such input may even improve the user-friendliness. In consideration of the above features of different operations, the above processing may be executed or may not be executed depending on whether or not a scrolling operation is a predetermined operation. For example, candidate designation numbers may be placed in an undisplayed state while a displayed candidate list is being scrolled through a flick operation, and in a displayed state while the displayed candidate list is being scrolled through a move operation.

While the above embodiments have described the case where candidate designation numbers are input from hardware keys, the present invention is also applicable to the case where candidate designation numbers are input from software keys. For example, when the candidate display button 203 is pressed on the software keyboard screen shown in FIG. 2, input through the user's touch operation may be enabled by displaying numeric keys together with the candidate list 204.

This concludes the description of embodiments. It should be noted that various devices may be used as the above information processing apparatus 101. For instance, the information processing apparatus 101 is not limited to a personal information processing apparatus, PDA and mobile telephone terminal. Other examples of the information processing apparatus 101 include a printer, scanner, facsimile machine, copier, multifunction peripheral, camera, video camera, and other image viewers. Furthermore, the present invention may be applied to a system including a plurality of apparatuses, or to an apparatus constituted by a single device.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-237271, filed on Oct. 26, 2012, which is hereby incorporated by reference herein in its entirety.

1. An information processing apparatus including a display unit provided with a touchscreen, the apparatus comprising:
display control means for displaying a part of a plurality of items in a form of a list on the display unit;
accepting means for accepting a touch operation applied by a user to the display unit; and
determination means for determining whether or not the touch operation accepted by the accepting means is an operation for scrolling the list while being displayed, wherein
when the determination means determines that the touch operation is the operation for scrolling the list while being displayed, the display control means further scrolls the list currently displayed on the display unit, and controls to place undisplayed items in a displayed state and to place information for selecting items included in the list in an undisplayed state.

2. The information processing apparatus according to claim 1, wherein
the display control means performs control to display the information for selecting the items upon completion of the scroll.

3. The information processing apparatus according to claim 1, wherein
the display control means scrolls the list currently displayed on a per-item basis in response to the operation for scrolling the list while being displayed.

4. The information processing apparatus according to claim 1, wherein
the display control means scrolls the list currently displayed in a predetermined unit corresponding to a display area of the list in response to the operation for scrolling the list while being displayed.

5. The information processing apparatus according to claim 4, wherein
after the list has been scrolled in response to the operation for scrolling the list while being displayed, the display control means performs control to place information for selecting items that are only partially displayed in an undisplayed state, and to display information for selecting items that are controlled to be entirely displayed.

6. The information processing apparatus according to claim 1, further comprising
input means for allowing the user to input the information for selecting the items included in the list displayed on the display unit.

7. The information processing apparatus according to claim 6, wherein
input via the input means is disabled while the list is being scrolled.

8. The information processing apparatus according to claim 6, wherein
when input is made via the input means while the list is being scrolled, the display control means stops the scroll.

9. The information processing apparatus according to claim 8, wherein
the display control means stops the scroll in a case where information input via the input means is valid as the information for selecting each item, and continues the scroll in a case where the information input via the input means is not valid as the information for selecting each item.

10. The information processing apparatus according to claim 1, wherein
the display control means calculates a moving amount by which the scroll is performed based on a position at which the display unit has been pressed, a position at which the pressing has been released, and a time period between the pressing and the release.

11. A control method for an information processing apparatus including a display unit provided with a touchscreen, the method comprising:
(a) displaying a part of a plurality of items in a form of a list on the display unit using display control means;
(b) accepting a touch operation applied by a user to the display means using accepting means; and
(c) determining whether or not the touch operation accepted using the accepting unit is an operation for scrolling the list while being displayed using a determination means, wherein
in (a), when the touch operation is determined to be the operation for scrolling the list while being displayed using the determination means, the list currently displayed on the display unit is scrolled, and control is performed to place undisplayed items in a displayed state and to place information for selecting items included in the list in an undisplayed state.

12. A computer-readable storage medium storing a computer program for causing a computer to execute the control method for the information processing apparatus according to claim 11.
